(19) United States
(12) Patent Application Publication
(10) Pub. No.: US 2019/0337089 A1
(43) Pub. Date: Nov. 7, 2019

(54) LASER-ASSISTED PRODUCTION METHOD FOR A GEARING COMPONENT AND GEARING

(71) Applicant: FLENDER GMBH, Bocholt (DE)

(72) Inventor: Jean-Andre Meis, Duelmen (DE)

(73) Assignee: FLENDER GMBH, Bocholt (DE)

(21) Appl. No.: 16/401,757

(22) Filed: May 2, 2019

(30) Foreign Application Priority Data
May 3, 2018 (EP) 18170551.8

(51) Int. Cl. B23K 20/24; B23K 15/00; B23K 26/361

(52) U.S. Cl. CPC B23K 20/24; B23K 26/361; B23K 15/0033

(57) ABSTRACT

In a method for making a tooth system of a gearing component, an unfinished tooth-system part is heat-treated. At least part of an oxide layer on the unfinished tooth-system part is mechanically removed, while leaving a residual oxide layer in at least one region, and the residual oxide layer is at least partially removed by irradiating with a laser at least a portion of the residual oxide layer.

### CROSS-REFERENCES TO RELATED APPLICATIONS

This application claims the priority of European Patent Application, Serial No. 18170551.8, filed May 3, 2018, pursuant to 35 U.S.C. 119(a)-(d), the disclosure of which is incorporated herein by reference in its entirety as if fully set forth herein.

### BACKGROUND OF THE INVENTION

The present invention relates to a method for producing a tooth system on a gearing component, to a computer program product, and to a processing apparatus for implementing the production method. The present invention also relates to a gearing.

The following discussion of related art is provided to assist the reader in understanding the advantages of the invention, and is not to be construed as an admission that this related art is prior art to this invention.

Gear-system engineering seeks to achieve ever greater power densities, resulting in increasing demands on all the components in a gearing system. In particular, there is a requirement both for greater utilization of the material employed and for fast and economic production of these components.

It would therefore be desirable and advantageous to obviate prior art shortcomings.

### SUMMARY OF THE INVENTION

According to one aspect of the present invention, a method for making a tooth system of a gearing component includes heat-treating an unfinished tooth-system part, mechanically removing at least partially an oxide layer on the unfinished tooth-system part, while leaving a residual oxide layer in at least one region, and removing at least partially the residual oxide layer by irradiating with a laser at least a portion of the residual oxide layer.

In accordance with the present invention, a tooth system is formed on a gearing component. The gearing component may be embodied as a ring gear, a planet gear, or a sun gear of a planetary gearset, for example. The gearing component may also be embodied as a gear wheel, i.e. a spur gear or bevel gear, of a spur gearset or of a bevel gearset. In a first step, an unfinished tooth-system part is provided, from which the gearing component is to be produced. The unfinished tooth-system part largely has a desired tooth profile, and undergoes a heat treatment in the first step. The heat treatment increases hardness of the material used. For example, the heat treatment can be in the form of case hardening and/or carbonitriding. Heat treatment of this type, for instance such as case hardening, involves carburization, in particular gas carburization, hardening and tempering of the unfinished tooth-system part. The heat treatment results in the formation on a surface of the unfinished tooth-system part of an oxide layer which reduces mechanical load-bearing capacity of the unfinished tooth-system part. In a second method step, the oxide layer on the unfinished tooth-system part is at least partially removed. The at least partial removal of the oxide layer is performed by a mechanical action on the unfinished tooth-system part. In a region of the unfinished tooth-system part that is inaccessible for mechanical removal, a residual oxide layer remains on the surface of the unfinished tooth-system part. The residual oxide layer is left accordingly and undergoes a further step in which the residual oxide layer is at least partially removed. This is realized by using a laser to irradiate at least a portion of the unfinished tooth-system part and to thereby eliminate the residual oxide layer. Optionally, position of the residual oxide layer can be detected beforehand, and used as a basis for the at least partial removal.

The laser or laser beam acts on a small area, essentially of diameters of a few micrometers, so that the amount of heat input to the unfinished tooth-system part can be kept low, even when eliminating an oxide layer. In the following description, the terms “laser” and “laser beam” are used essentially synonymously. A defined state produced in the unfinished tooth-system part by the heat treatment is unaffected in this process. Furthermore, the laser irradiation of the residual oxide layer preserves the residual compressive stresses that are present in the unfinished tooth-system part. It is thereby possible to minimize the detrimental effect of the residual oxide layer, also known as surface oxidation, while retaining the advantageous effect of the heat treatment. The residual oxide layer can be irradiated by the laser quickly in portions, with the result that it can be removed substantially completely.

According to another advantageous feature of the present invention, the laser can be configured to cause a melting and/or vaporizing of the residual oxide layer to eliminate the residual oxide layer. This is the case when the residual oxide layer is designed to absorb the laser and to convert at least some of the energy therefrom into thermal energy. Alternatively, i.e. with regard to material of the residual oxide layer, which material is unable to absorb the laser, the laser can be designed to melt or vaporize a base material layer. The base material layer here refers to a region of the unfinished tooth-system part that lies substantially directly beneath the residual oxide layer. The base material layer thus constitutes the region of the unfinished tooth-system part that is covered directly by the residual oxide layer. Heat input by the laser to melt or vaporize the base material layer causes the residual oxide layer to peel off in this region. In both cases, a relatively large portion of the residual oxide layer is removed by a lower heat input via the laser. This allows a high process speed for a method according to the present invention. Furthermore, any impairment on the surface of the unfinished tooth-system part is kept low, and the aforementioned advantages are substantially achieved.

According to another advantageous feature of the present invention, the unfinished tooth-system part can be mechanically strengthened after at least partially removing the residual oxide layer. Mechanical strengthening is advantageously performed in a region that is cleaned of the residual oxide layer by the laser. The mechanical strengthening is in the form of shot blasting, for example. The mechanical strengthening introduces additional residual stress, in particular residual compressive stress, on the surface of the unfinished tooth-system part. The less a surface is contaminated, i.e. occupied, by a residual oxide layer, the higher is the effectiveness of such a strengthening step. Thus, a method according to the present invention can be used to achieve a high level of strength in an unfinished tooth-system part. Overall, quality for a gearing component to be produced can be enhanced with more efficient material utilization.

Mechanical removal of the oxide layer can also be performed by abrasive blast cleaning, in particular shot blasting. Alternatively or additionally, the at least partial mechanical removal of the oxide layer can be in the form of water-jet blasting or brushing. Abrasive blast cleaning allows rapid planar removal of the oxide layer and allows residual stress to be introduced into the unfinished tooth-system part. Abrasive blast cleaning leaves a residual oxide layer that is relatively small in area, which then must undergo laser-assisted processing. After abrasive blast cleaning, the residual oxide layer remains, inter alia, in channels and grooves in the surface of the unfinished tooth-system part. Overall, abrasive blast cleaning allows the gearing component to be produced with a high level of efficiency.

According to another advantageous feature of the present invention, wherein the unfinished tooth-system part can be produced from a free-machining steel, a case-hardened steel, a heat-treatable steel, a nitrided steel or a hardened steel. Such steels offer good machinability and can be processed further effectively by heat treatment, in particular case hardening and/or carbonitriding. In addition, such steels have a high surface quality and a reduced tendency to oxidation, and therefore the residual oxide layer proves to be small. This reduces the amount of work needed to perform a method according to the present invention.

According to another advantageous feature of the present invention, the residual oxide layer can be in the form of surface oxidation and can have a thickness of 10 μm to 100 μm. The heat treatment is adapted in terms of its process parameters, for instance the carburization temperature, to leave behind a residual oxide layer of corresponding thickness. The laser is parameterized to melt or vaporize a residual oxide layer of this thickness. Alternatively, the laser is parameterized to get a residual oxide layer of corresponding thickness to peel off by melting or vaporizing a base material layer lying directly beneath the layer. The energy required for the laser in this process, at least some of which energy exists as thermal energy in the unfinished tooth-system part after the irradiation, is low enough for a thermal effect on the action of the case hardening to be negligible. In addition, the laser achieves a suitable processing depth to allow the residual oxide layer to be removed or eliminated by a short irradiation. The greater the depth of the hardening during the heat treatment, the greater the thickness of the residual oxide layer. This depth depends, for example, on the temperature and duration of the heat treatment. The at least partial mechanical removal of the oxide layer in the second method step can hence be adjusted according to the process parameters of the heat treatment. The process parameters of the heat treatment, of the at least partial mechanical removal of the oxide layer, and/or the outlined parameters of the laser can be adjusted accordingly by a user or a computer program product.

According to another advantageous feature of the present invention, the at least one region in which the residual oxide layer remains can be a tooth base on the tooth system to be produced. The tooth base of a tooth system constitutes a region in which processing, in particular removal of a residual oxide layer, is prevented in the solutions according to the prior art. The invention is based, inter alia, on the knowledge that the residual oxide layer in the region of a tooth base has a particularly detrimental effect on the mechanical load-bearing capacity of a tooth system. By virtue of the laser-assisted removal of the residual oxide layer at the tooth base, it is possible to suppress these detrimental effects while avoiding the unfavorable aspects of other processing techniques. By employing a laser-assisted removal of the residual oxide layer at the tooth base, it is possible to increase the base load-carrying capacity of a tooth system for the same amount of material use. This allows greater utilization of the material used for the tooth system and/or the gearing component.

According to another advantageous feature of the present invention, the laser can be oriented on the basis of a reference profile of the tooth system to be produced or on the basis of a detected actual profile of the unfinished tooth-system part. This can be defined, for example, via the CAD data for the desired tooth system. The higher the manufacturing quality, the smaller is a difference between an existing actual profile and a desired reference profile. The reference profile as the basis for irradiating the residual oxide layer does not require any complex detection means for determining an existing actual profile, and allows a method according to the present invention to be performed quickly and cost-effectively. Alternatively, the laser can also be oriented on the basis of a detected actual profile of the unfinished tooth-system part. For instance, detection can be performed by means of an optical measurement. In particular, the actual profile can be detected using the laser that is also used for at least partially removing the residual oxide layer. This is implemented by suitable adjustment of the intensity of the laser beam, i.e. advantageously by setting a reduced intensity. By detecting the actual profile, it is possible to identify unforeseen impairments in the unfinished tooth-system part and to adjust the claimed method appropriately. This achieves a high level of processing precision and a lower failure rate in the production of the gearing components.

According to another advantageous feature of the present invention, the laser can be positioned, i.e. arranged, such that during the irradiation of the residual oxide layer, it is substantially equidistant from a tooth profile to be irradiated. The residual oxide layer to be removed lies in the tooth profile to be irradiated, and therefore the equidistance makes the laser irradiation simpler. In particular, this makes a parameter change unnecessary, for instance changing a focal point of the laser. Thus essentially a large portion of the tooth profile can be traversed by the laser, and hence cleaned of the residual oxide layer, without any changes to the parameter settings of the laser. This allows a method according to the present invention to be performed quickly and efficiently. For a tooth profile that is constant along a tooth width, the laser can be moved substantially linearly along the tooth width and hence the irradiation even of tooth profiles of large area can be performed more quickly. A method according to the present invention is thus scalable and can be used for a wide range of gear sizes.

According to another advantageous feature of the present invention, the unfinished tooth-system part can remain in a same clamp in a clamping mechanism while the residual oxide layer is at least partially removed and the unfinished tooth-system part is mechanically strengthened. Laser irradiation and mechanical strengthening can hence be performed quickly in succession and with less work involved. This simplifies implementation of a method according to the present invention.

According to another aspect of the present invention, a non-transitory computer program product for defining orientation, intensity and/or focal point of a laser includes program instructions which when loaded into a memory of a controller causes the controller to a method according to the present invention. The computer program product is designed for remanent storage and execution in a memory of a controller. The computer program product can integrate all the functions here, i.e. have a monolithic design. The computer program product may be in the form of software and/or be hardwired. Hardwiring refers, for example, to providing the computer program product as an application-specific integrated circuit, ASIC for short, or as a system of FPGAs. Alternatively, the computer program product can also be split into functional segments, which can be stored and executed independently and which interact with one another functionally. The controller may be embodied as a single control box, as a computer, or as a higher-level controller at a remote location, for instance as a computer cloud. The computer program product can be designed to define parameters for operating a laser and hence to control the laser by outputting commands. Parameters for operating the laser may be, for example, the laser orientation, an intensity, a focal-point distance, a pulse width, or other parameters outlined above. Likewise, the computer program product can be designed to move a clamp, in which the unfinished tooth-system part is located during the method, so as to process different portions of the unfinished tooth-system part. The computer program product can be designed to control in a suitable manner a laser in a production method according to at least one of the embodiments outlined above. The computer program product ensures that a method according to the present invention is implemented simply and in a rapidly adaptable manner.

According to still another aspect of the present invention, an apparatus includes a clamping mechanism for fixing an unfinished tooth-system part, a first tool unit configured to mechanically remove an oxide layer on the unfinished tooth-system part, a laser unit configured to irradiate at least one region of the unfinished tooth system pat and a controller including a memory for storing and executing a computer program product as set forth above. The apparatus is used to produce a tooth system of a ring gear, of a planet gear, of a sun tooth system, or of a gear wheel of a spur gearset or a bevel gearset. For this purpose, the apparatus comprises a clamping mechanism, which is designed to provide a releasable fixing mechanism for the unfinished tooth-system part. The apparatus also includes a first tool unit, configured for mechanical removal of an oxide layer formed on the unfinished tooth-system part during heat treatment. For this purpose, the first tool unit can be designed as a shot blasting device, for example. The apparatus also includes a laser unit to irradiate the unfinished tooth-system part at least in portions. The laser unit has for this purpose a laser, which is designed to be adjustable, and hence controllable, in terms of orientation, intensity, focal-point distance and/or pulse width, by a user or a computer program product. The irradiation of at least portions of the unfinished tooth-system part is used for at least partial removal of a residual oxide layer that is present in the relevant portion. The apparatus has a controller that is designed to store remanently in a memory, and execute, a computer program product. The computer program product is designed to implement on the apparatus according to the invention, a method according to the present invention by suitable control of at least one component of the apparatus, in particular the laser unit. The components of the apparatus, for example the clamping mechanism, the first tool unit and/or the laser unit, can be integrated structurally in the apparatus or be embodied as interacting modules. Interacting modules include, for example, industrial robots that work together.

According to still another aspect of the present invention, a gearing component, includes a main body having a tooth system and embodied as a ring gear, a planet gear, or a sun gear of a planetary gearset, or as a gear wheel of a spur gearset or of a bevel gearset, wherein the tooth system is produced by a method as set forth above. According to the invention, the tooth system of the gearing component can be produced by a method according to the present invention. Such a gearing component provides a higher degree of strength and thus allows greater material utilization. This also allows the gearing component to have a weight-saving design.

According to yet another aspect of the present invention, a gearing embodied as a planetary gearset, as a spur gearset, or as a bevel gearset includes a gearing component as set forth above, i.e. is produced by a method according to the present invention,

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic microscopic sectional view of a surface of an unfinished tooth-system part between two method steps according to the present invention;

FIG. 2 is a schematic view of an unfinished tooth-system part during a third method step according to a first embodiment of a method according to the present invention;

FIG. 3 is a schematic view of an unfinished tooth-system part during a third method step according to a second embodiment of a method according to the present invention;

FIG. 4 is a schematic microscopic sectional view of a surface of an unfinished tooth-system during the third method step;

FIG. 5 is a schematic illustration of an apparatus according to the present invention; and

FIG. 6 is a sequence diagram of making a tooth system of a gearing component in accordance with the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

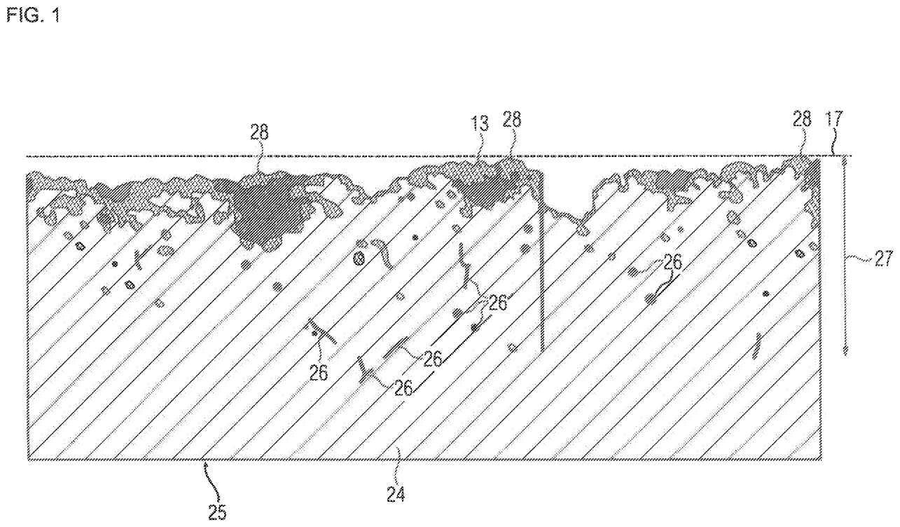

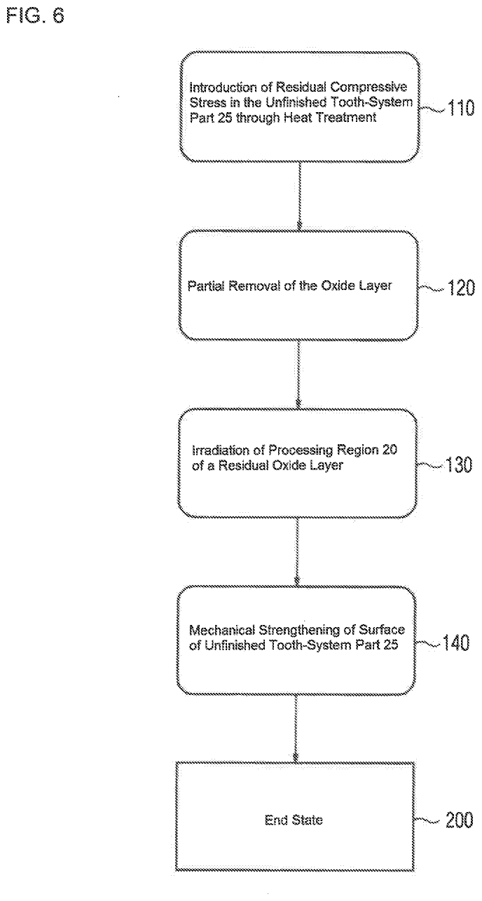

Turning now to the drawing, and in particular to FIG. 1, there is shown a schematic microscopic sectional view of a surface 13 of an unfinished tooth-system part, generally designated by reference numeral 25 and intended to be processed into a gearing component. The surface 13 shown in FIG. 1 is part of a tooth system 12 to be produced. The unfinished tooth-system part 25 includes a base material layer 24, which is located mainly inside the unfinished tooth-system part 25. The base material layer 24 is made of a metallic material, for instance a free-machining steel, a case-hardened steel, a heat-treatable steel, a nitrified steel or a hardened steel. In a first method step 110 (FIG. 6), residual compressive stress is introduced in the unfinished tooth-system part 25 as a result of a heat treatment in the form of case hardening. Alternatively, other forms of heat treatment can also be used. Formed on the base material layer 24 is a residual oxide layer, which remains on the surface 13 after partial removal of an oxide layer (not shown).

FIG. 1 depicts the unfinished tooth-system part 25 between a second method step 120 (FIG. 6), in which the oxide layer is partially removed, and a third method step 130 (FIG. 6), in which the residual oxide layer is treated. The residual oxide layer is formed mainly as oxide inclusions 26, which lie in the region of the surface 13. Measured relative to a surface reference plane 17, which lies in the region of a highest roughness point 28 of the surface 13, the oxide inclusions 26 are situated at a depth of 10 μm to 100 μm in the unfinished tooth-system part 25. This defines a layer thickness 27, represented by a double-ended arrow, of the residual oxide layer. In addition, the oxide layer may also have a cracked structure.

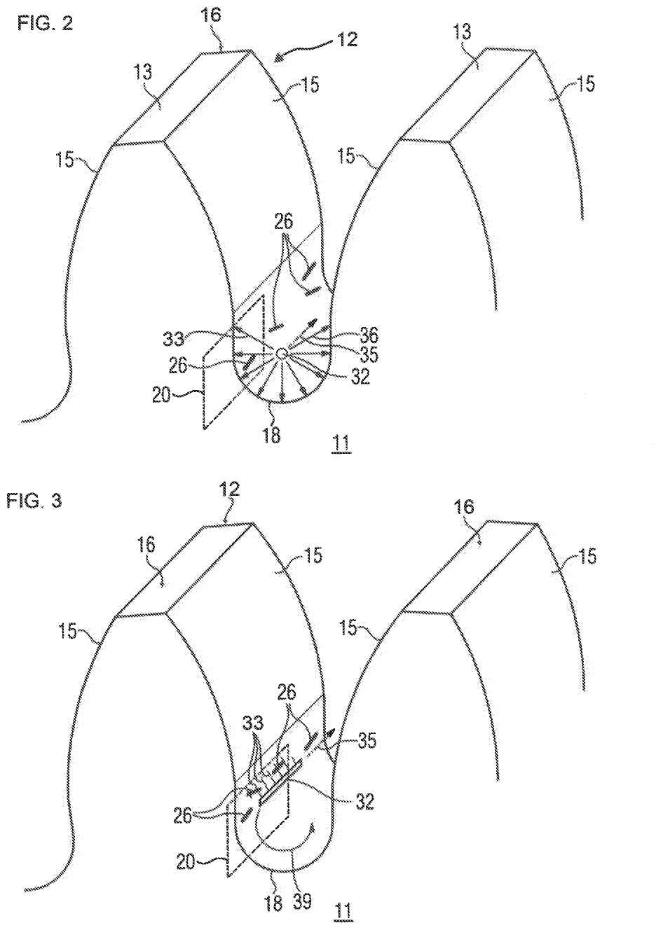

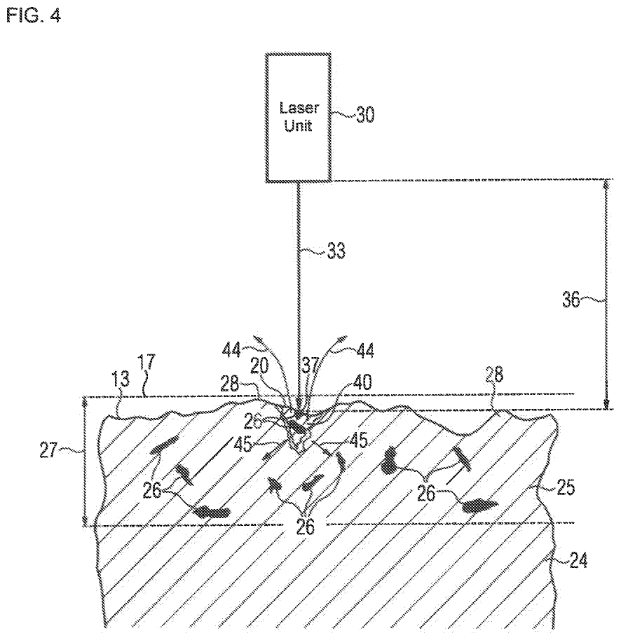

FIG. 2 shows schematically a segment of the unfinished tooth-system part 25, which is to be processed into a gearing component, such as a gear tooth 16. The unfinished tooth-system part 25 includes a main body 11, on which the tooth system 12 is to be formed. FIG. 2 represents a schematic view of the unfinished tooth-system part according to a first embodiment of a method of the present invention. The tooth system 12 has a plurality of teeth 16. After undergoing the heat treatment, in particular case hardening, in method step 110, and partial removal of the oxide layer formed thereby on the surface 13 in method step 120, a residual oxide layer is formed on a tooth flank 15 in the region of a tooth base 18. The residual oxide layer includes oxide inclusions 26, which are contained in the surface 13. During the third method step 130 depicted in FIG. 2, a processing region 20 on the surface 13 of the unfinished tooth-system part 25 is irradiated. A laser 32 associated with a laser unit 30 (FIG. 4) performs the irradiation. For this purpose, the laser 32 directs laser beams 33 onto the processing region 20, in which a residual oxide layer in the form of oxide inclusions 26 is located. Irradiation by the laser 32 causes melting and/or vaporization of oxide inclusions 26. Material from the base material layer 24 may also be melted or vaporized as well by the irradiation.

The laser 32 can be controlled by a user or a computer program product (not shown in further detail), e.g. by controlling intensity. The laser 32 can move along a profile of the tooth base 18 and/or of the tooth flanks 15. By an appropriate processing movement as indicated by dash-dotted arrow 35, the tooth flanks 15 and the tooth base 18 can be irradiated by the laser 32 in portions, i.e. in a plurality of processing regions 20. The irradiation by the laser 32 removes the residual oxide layer at least partially. Irradiation by the laser 32 enables to counteract the strength-reducing effect of the oxide inclusions 26 while preserving any residual compressive stress present in the unfinished tooth-system part 25. The laser 32 is positioned substantially equidistant from the tooth flanks 15 and the tooth base 18. By means of a simple, substantially linear, movement of the laser 32, it is possible to irradiate a large region of the unfinished tooth-system part 25 without a change in the settings of the laser 32. In particular, during the processing movement 35, the surface 13 is irradiated at a constant focal-point distance as indicated by arrow 36. This facilitates rapid manufacture.

FIG. 3 shows schematically a second embodiment of the third method step 130. Same reference characters in FIG. 3 have a same technical meaning as in FIG. 2. According to the embodiment shown in FIG. 3, the laser beams 33 in the processing region 20 are directed substantially linearly onto the surface 13. In addition to a processing movement 35 along the tooth base 18, a rotational movement of the laser 32 as indicated by arrow 39 is executed. During the rotational movement 39, by virtue of a known profile of the surface 13 in the region of the tooth flanks 15 and of the tooth base 18, it is easily possible to adjust the settings of the laser 32, in particular the focal-point distance 36. This allows the laser 32 to be adapted easily to the shape of the unfinished tooth-system part 25 to be processed, and provides particularly thorough removal of the residual oxide layer. This is accordingly repeated portion by portion for a plurality of processing regions 20.

FIG. 4 shows a schematic microscopic sectional view of the surface 13 of the unfinished tooth-system during the third method step 130, as the surface 13 is irradiated by the laser 32 of laser unit 30. The third method step 130 is performed in a processing region 20, in which the surface 13 of the tooth system 12 on the unfinished tooth-system part 25 is being processed. The unfinished tooth-system part 25 is in particular a gearing component. A laser beam 33 is directed with selectable intensity onto the surface 13 which has formed thereon at least on a portion thereof a residual oxide layer in the form of a plurality of oxide inclusions 26, which are disposed in the base material layer 24. The position of the oxide inclusions 26 defines in relation to the reference plane 17 a layer thickness 27 which is selected such that the reference plane 17 envelops the roughness points 28 lying on the surface 13. The layer thickness 27 equals between 10 μm and 100 μm. The base material layer 24 contains no oxide inclusions 26 below the residual oxide layer, and is interspersed with oxide inclusions 26 in the region of the residual oxide layer.

The laser beam 33 is directed with selectable intensity onto a surface fragment 40, on which a focal point 37 of the laser beam 33 is located. The position of the focal point 37 can be selected, inter alia, by setting the focal-point distance 36. Thus the laser 32 supplies the surface fragment 40 with energy, which is converted there into thermal energy. The supply of thermal energy causes vaporization of the surface fragment 40 at least to some extent. Remaining pieces of the surface fragment 40 are removed mechanically by resultant pressure during at least partial vaporization. In this process, non-vaporized pieces of the surface fragment 40 peel off as indicated by arrow 44. In addition, vaporization and peeling-off of the surface fragment 40 can be adjusted by an irradiation period that can be selected by the user and/or a computer program product. Heat input by the laser beam 33 from surface fragment 40 to be removed into the base material layer 24, as indicated by arrow 45, is reduced by performing vaporization and peeling-off in a short time interval. At least irradiation period, intensity and the focal-point distance 36 can be suitably selected such that at least partial vaporization and peeling-off of the surface fragment 40 in method step 130 takes places reliably in as short a time period as possible with minimum energy input from the laser 32.

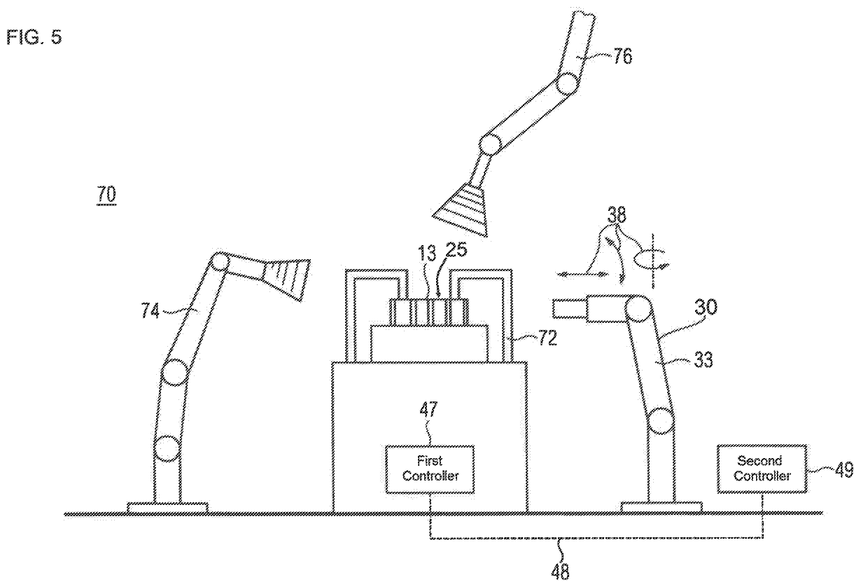

Referring now to FIG. 5, there is shown a schematic illustration of a processing apparatus according to the present invention, generally designated by reference numeral 70, for implementing a production method according to the present invention. The processing apparatus 70 includes a clamping mechanism 72, in which an unfinished tooth-system part 25 is clamped during the production method. The processing apparatus 70 is used to process a tooth system 12 on the unfinished tooth-system part 25, in order to produce thereby a gearing component from the unfinished tooth-system part 25. In the course of the first method step 110, the unfinished tooth-system part 25, which is case-hardened, is clamped in the clamping mechanism 72. The processing apparatus 70 includes a first tool unit 74, e.g. a shot blasting system, to remove, in the second method step 120, mechanically at least partially the oxide layer produced on the surface 13 of the unfinished tooth-system part 25 during heat treatment, such as case hardening for instance. After partial mechanical removal, remaining parts of the oxide layer form the residual oxide layer. The residual oxide layer is removed at least partially by the laser unit 30 in the third method step 130. For this purpose the laser 32 of the laser unit 30 emits a laser beam 33. The laser unit 30 is designed to be moved along a plurality of movement axes indicated by arrows 38 so as to achieve, for example, a desired orientation and/or a rotational movement of the laser 32, and to guide the laser 32 along the direction of the desired processing movement 35. In addition, the laser beam 33 emitted by the laser 32 can be adjusted, at least in terms of intensity, focal-point distance 36 and irradiation period. The adjustment is implemented by an input from a user and/or by a computer program product, by means of which, inter alia, the laser unit 30 is controlled.

The processing apparatus 70 further includes a second tool unit 76, e.g. a shot blasting system. The second tool unit 76 is intended to process the unfinished tooth-system part 25 in the fourth method step 140, and thereby achieve mechanical strengthening of the surface 13 of the unfinished tooth-system part 25. The processing apparatus 70 also includes a first controller 47, which is assigned directly to the processing apparatus 70. A computer program product remanently stored in the first controller 47 is executed there. The computer program product is designed to execute at least part of the production method according to the present invention. For this purpose, the computer program product can control the first tool unit 74, the second tool unit 76 and/or the laser unit 30 In an open-loop and/or closed-loop manner. The first controller 47 Is connected via a data link 48 to a second controller 49, on which is also remanently stored a computer program product, which can be executed on the second controller 49. The computer program products in the first and second controllers 47, 49 communicate via the data link 48. Individual functions of the production method, for instance individual method steps 110, 120, 130, 140, or inputs of parameters, for instance irradiation period and/or intensity of the laser beam 33, can be implemented separately on the two controllers 47, 49. The data link 48 realizes, in conjunction with the first and second controllers 47, 49, the production method using the production apparatus 70.

FIG. 6 is a sequence diagram of making a tooth system 12 of, e.g., a gearing component in accordance with the present invention. The production method includes the first method step 110, in which the unfinished tooth-system part 25 is in the state after case hardening, and has an oxide layer on its surface 13. In the following second method step 120, the first tool unit 74 performs at least partial mechanical removal of the oxide layer. As a result of the second method step 120, a residual oxide layer still remains from the oxide layer on the unfinished tooth-system part 25. In the following third method step 130, the laser unit 30 is used to remove the residual oxide layer at least partially. The laser unit 30 directs the laser 32 onto the unfinished tooth-system part 25. Intensity of the laser 32 is adjustable by a setting from a user and/or from a computer program product In the fourth method step 140, the second tool unit 76 is used to achieve mechanical strengthening on the surface 13 of the unfinished tooth-system part 25. The fourth method step 140 is followed by an end state 200 of the production method. In the end state 200, the unfinished tooth-system part 25 is removed as gearing component for optional further processing.

The production method as shown in FIG. 6 can be used to produce ring gears, planet gears, and sun gears for a gearing 61, in particular a planetary gearing. It is equally possible to use the described production method to produce also gear wheels for spur gearing or bevel gearing.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A method for making a tooth system of a gearing component, comprising:
heat-treating an unfinished tooth-system part;
mechanically removing at least partially an oxide layer on the unfinished tooth-system part, while leaving a residual oxide layer in at least one region; and
removing at least partially the residual oxide layer by irradiating with a laser at least a portion of the residual oxide layer.

2. The method of claim 1, wherein the laser causes a melting and/or vaporizing of the residual oxide layer or of a base material layer covered directly by the residual oxide layer.

3. The method of claim 1, further comprising mechanical strengthening the unfinished tooth-system part after at least partially removing the residual oxide layer.

4. The method of claim 1, wherein the mechanical removal of the oxide layer is executed by a process selected from the group consisting of abrasive blast cleaning, brushing, and a combination thereof.

5. The method of claim 4, wherein the abrasive blast cleaning includes shot blasting and water jet blasting.

6. The method of claim 1, wherein the unfinished tooth-system part is produced from a free-machining steel, a case-hardened steel, a heat-treatable steel, a nitrided steel or a hardened steel.

7. The method of claim 1, wherein the residual oxide layer is in the form of surface oxidation and has a thickness of 10 μm to 100 μm.

8. The method of claim 1, wherein the at least one region in which the residual oxide layer remains is a tooth base.

9. The method of claim 1, wherein the laser is oriented on the basis of a reference profile of the tooth system to be produced or on the basis of a detected actual profile of the unfinished tooth-system part.

10. The method of claim 1, wherein the laser is arranged equidistant from a tooth profile to be irradiated.

11. The method of claim 3, wherein the unfinished tooth-system part remains in a same clamp in a clamping mechanism while the residual oxide layer is at least partially removed and the unfinished tooth-system part is mechanically strengthened.

12. A non-transitory computer program product for defining orientation, intensity and/or focal point of a laser, said computer program product comprising program instructions which when loaded into a memory of a controller causes the controller to perform the steps of
heat-treating an unfinished tooth-system part;
mechanically removing at least partially an oxide layer on the unfinished tooth-system part, while leaving a residual oxide layer in at least one region; and
removing at least partially the residual oxide layer by irradiating with a laser at least a portion of the residual oxide layer.

13. Apparatus, comprising:
a clamping mechanism for fixing an unfinished tooth-system part;
a first tool unit configured to mechanically remove an oxide layer on the unfinished tooth-system part;
a laser unit configured to irradiate at least one region of the unfinished tooth-system part; and
a controller including a memory for storing and executing a computer program product as set forth in claim 12.

14. A gearing component, comprising a main body having a tooth system and embodied as a ring gear, a planet gear, or a sun gear of a planetary gearset, or as a gear wheel of a spur gearset or of a bevel gearset, wherein the tooth system is produced by a method as set forth in claim 1.

15. A gearing embodied as a planetary gearset, as a spur gearset, or as a bevel gearset, said gearing comprising a gearing component as set forth in claim 14.
